(19) United States
(12) Patent Application Publication
(10) Pub. No.: US 2024/0165837 A1
(43) Pub. Date: May 23, 2024

(54) ELECTRIC SCISSORS

(71) Applicant: Jing Hong LEI, Rosemead, CA (US)

(72) Inventor: Bin Qiu LI, Rosemead, CA (US)

(21) Appl. No.: 17/990,261

(22) Filed: Nov. 18, 2022

(51) Int. Cl. B26B 15/00

(52) U.S. Cl. CPC B26B 15/00

(57) ABSTRACT

A pair of electric scissors includes a first shell and a second shell detachably connected together. A driving module, including a driving member and a moving member, detachably connected within the first shell. The moving member is driven by the driving member. A shearing module, including a driven portion, detachably connected with the first shell. The driven portion is connected with the moving member right after both the driving module and the shearing module are connected with the first shell. A power supply module detachably connected within the second shell. The power supply module is connected with the driving member right after the second shell is connected with the first shell.

### BACKGROUND OF INVENTION

### 1. Field of Invention

The present invention relates to scissors and, more particularly, to electric scissors capable of automatic shearing.

### 2. Related Prior Art

Scissors are hand tools commonly used in daily life. However, two fingers are required to be opened and closed repeatedly to operate, which is easy to cause fatigue and cannot continue to work. Therefore, electric scissors capable of automatic shearing are developed.

A pair of electric scissors basically includes a motor, a battery and blades. The battery supplies electricity, and the motor drives the blades to cut. These components are usually housed in a shell which can be held in user's hand as a handle. A kind of electric scissors disclosed in China Patent CN 208972016 U includes a shell composed of left and right half parts each having a height equal to that of the whole shell. During assembling, motor, battery and blades are put into one of the half parts one by one, probably positioned with additional positioning manners, and then finishing the assembling by combining the other half part. If anyone of the components has to be replaced, one of the half parts must be removed to expose all the components before the component to be replaced can be removed.

### SUMMARY OF INVENTION

It is the primary objective of the present invention to provide a pair of electric scissors to solve the problem above-mentioned.

To achieve the foregoing objective, the present invention provides a pair of electric scissors having a housing including a first shell and a second shell detachably connected together. A driving module is detachably connected within the first shell and includes a driving member and a moving member driven by the driving member. The moving member extends into the first shell. A shearing module is detachably connected with the first shell and includes a driven portion that is connected with the moving member right after both the driving module and the shearing module are connected with the first shell. A power supply module is detachably connected with the second shell. The power supply module is connected with the driving member right after the second shell is connected with the first shell.

In one embodiment, the first shell and the second shell are arranged in a straight axis. A bottom end of the first shell is screwed to a top end of the second shell. The driving module and the power supply module are arranged in the straight axis. The shearing module is arranged at an angle relative to the straight axis.

In one embodiment, an upper space and a lower space are provided in an interior of the first shell. The driving member is fitted with the first shell in the lower space while the moving member extends into the upper space.

Preferably, a step portion is disposed in the first shell to divide the interior into the upper space and the lower space. The driving member is positioned with engaging with the step portion. A washer is provided between the driving member and the step portion.

In one embodiment, the driving member includes a motor and a circuit board disposed under the motor. A conductive contact is provided on a surface of the circuit board facing the power supply module.

Preferably, the power supply module includes a battery and a switch. A conductive board coupled to the conductive contact is disposed on a side of the battery facing the circuit board. The switch is disposed on another side of the battery opposite to the side of the battery facing the circuit board. A bottom end of the second shell is connected with a bottom cover with a button linked to the switch.

Preferably, a charging connector is disposed on a radial side of the battery.

In one embodiment, the driving member includes a motor with an output shaft. The output shaft is connected with a rotating base. The moving member is disposed on the rotating base in a position different from that of the output shaft so that the moving member moves along with a rotation of the rotating base.

In one embodiment, the shearing module includes a first blade and a second blade. The first blade is fixed with the first shell. The second blade is pivotally connected to the first blade with a pivot module. The driven portion is disposed on the second blade.

Preferably, at least one screw hole is provided on the first shell while the first blade is fixed by at least one screw locked in corresponding screw hole.

Preferably, the driven portion includes two rods spaced apart. The moving member extends between the two rods and repeatedly pushes the two rods one after another so that the second blade swings back and forth.

Preferably, the pivot module includes a pivot rod, a sleeve with a bottom plate, a spring and a supporting block. The pivot rod penetrates the first blade and the second blade and then is fixed with the supporting block. The sleeve is disposed around the pivot rod while the bottom plate engages with the second blade. The spring is disposed around the pivot rod and supported by the supporting block and the bottom plate.

Preferably, the first blade includes two blade portions spaced apart. The second blade swings between the two blade portions.

In one embodiment, a part of the driving member sticks out from the first shell. The second shell includes an upper portion detachably connected with the first shell and a lower portion detachably connected with the upper portion. The part of the driving member sticking out from the first shell is received within the upper portion. The power supply module is received within the lower portion.

### BRIEF DESCRIPTION OF DRAWINGS

The present invention will be described via detailed illustration of the preferred embodiment referring to the drawings wherein:

FIG. 1 is a perspective view of a first embodiment of the present invention;

FIGS. 2 and 3 are perspective exploded views of the first embodiment of the present invention;

FIG. 4 is a cross-sectional view of the first embodiment of the present invention;

FIGS. 5 and 6 illustrate how the driving module drives the shearing module;

FIG. 7 illustrates assembling of the first embodiment of the present invention;

FIG. 8 is a perspective view of a second embodiment of the present invention.

### DETAILED DESCRIPTION OF PREFERRED EMBODIMENT

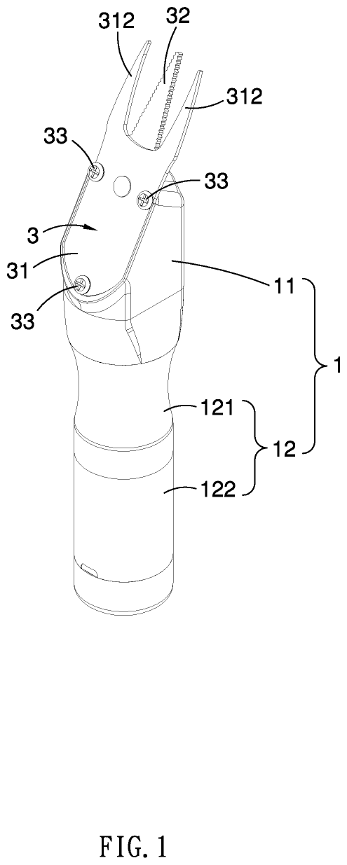

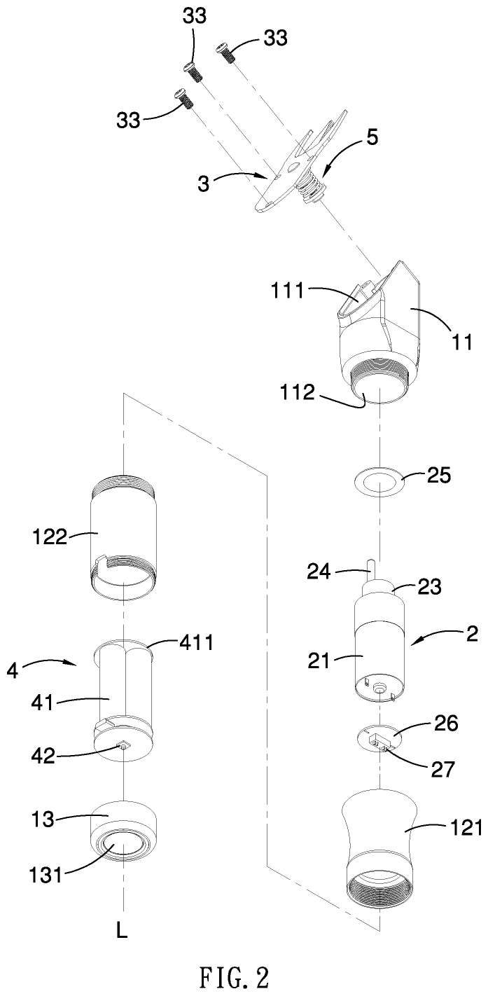

FIGS. 1 to 4 show a first embodiment of a pair of electric scissors of the present invention, including a housing 1, a driving module 2, a shearing module 3 and a power supply module 4. The driving module 2 and the power supply module 4 are arranged in a straight axis L and accommodated in the housing 1. The housing 1 is divided into a first shell 11 and a second shell 12 that are arranged in the straight axis L. The second shell 12 further includes an upper portion 121 and a lower portion 122 that are arranged in the straight axis L. The upper portion 121 is detachably connected with the first shell 11 while the lower portion 122 is detachably connected with the upper portion 121. In this embodiment, the upper portion 121 is screwed to the first shell 11, and the lower portion 122 is screwed to the upper portion 121.

A space with an upper opening 111 and a lower opening 112 is enclosed by the first shell 11. Normal direction of the lower opening 112 is parallel to the straight axis L while normal direction N of the upper opening 111 is at an angle θ of 0 to 90 degrees relative to the straight axis L. In this embodiment, a step portion 113 is disposed in the first shell 11 to partition the interior of the first shell 11 into an upper space 114 adjacent to the upper opening 111 and a lower space 115 adjacent to the lower opening 112.

The driving module 2 includes a driving member and a moving member 24 driven by the driving member. In this embodiment, the driving member includes a motor 21 with an output shaft 22 connected with a round rotating base 23. The moving member 24 is formed as a thin stick and disposed on the rotating base 23 in a position different from that of the output shaft 22. Accordingly, during the motor 21 driving the output shaft 22 to rotate, the rotating base 23 is driven to rotate, and thus the moving member 24 moves along a circular path.

The motor 21 is inserted into the lower space 115 through the lower opening 112 and engages with the step portion 113 for positioning.

The moving member 24 extends into the upper space 114. A bottom end of the motor 21 sticks out of the lower opening 112. On the other hand, the bottom end of the motor 21 is received in the upper portion 121 of the second shell 12. Preferably, a washer 25 made of metal or rubber is provided between the motor 21 and the step portion 113. Additionally, a circuit board 26 with a conductive contact 27 is disposed on the bottom end of the motor 21. The conductive contact 27 is located on a surface of the circuit board 26 facing the power supply module 4 for coupling to the power supply module 4.

The power supply module 4 is received in the lower portion 122 of the second shell 12, including a battery 41 and a switch 42. A conductive board 411 configured to couple to the conductive contact 27 is disposed on a side of the battery 41 facing the circuit board 26. The switch 42 configured to turn on/off the power supply of the battery 41 is disposed on another side of the battery 41 opposite to the side of the battery 41 facing the circuit board 26. A radial side of the battery 41 is provided with a charging connector 412 for connecting to an external power supply device for charging.

Furthermore, a bottom cover 13 with a button 131 is screwed to the lower portion 122 of the second shell 12. The switch 42 is linked to the button 131 so that the switch 42 is operated to turn on/off the power supply of the battery 41 by pressing the button 131.

The shearing module 3 includes a first blade 31 and a second blade 32. The first blade 31 is fixed on the upper opening 111 of the first shell 11. Based on the normal direction N of the upper opening 111 being tilted from the straight axis L, the first blade 31 extends in a tilted direction relative to the straight axis L. In this embodiment, the upper opening 111 is provided with three screw holes 116 while the first blade 31 is provided with three through holes 311. Three screws 33 penetrate the first blade 31 and then are screwed to corresponding screw holes 116 so that the first blade 31 is fixed on the first shell 11.

The second blade 32 is disposed on inner side of the first blade 31, that is, in the upper space 114 of the first shell 11. The second blade 32 is connected to the first blade 31 with a pivot module 5 including a pivot rod 51, a sleeve 52 with a bottom plate 521, a spring 53 and a supporting block 54. The pivot rod 51 penetrates the first blade 31, the second blade 32 and the sleeve 52, and a terminal end of the pivot rod 51 is screwed to the supporting block 54. The bottom plate 521 of the sleeve 52 engages with the second blade 32. The spring 53 is disposed around the pivot rod 51 with two ends are supported by the supporting block 54 and the bottom plate 521 respectively. Accordingly, the sleeve 52 abuts against the second blade 32 thinly via the spring 53, and thus the second blade 32 further abuts against the first blade 31 firmly for stable assembly and enhanced shearing.

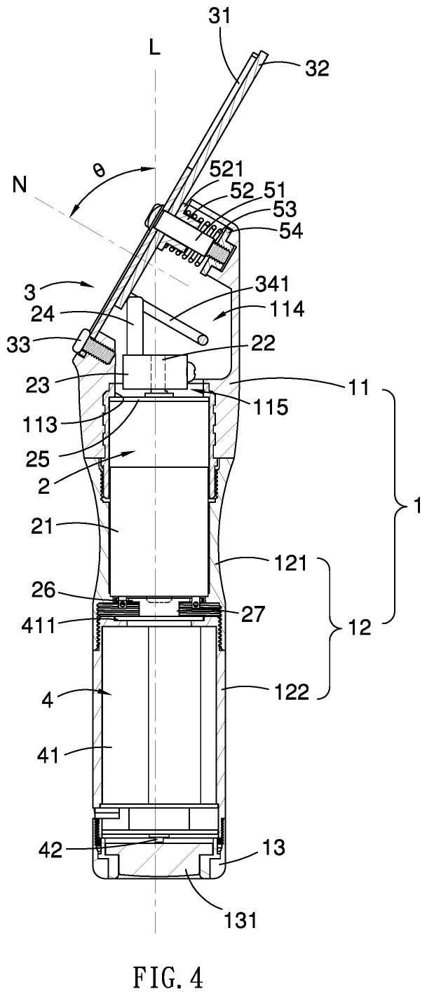

The second blade 32 is provided with a driven portion 34 configure to be connected with the moving member 24. The driven portion 34 includes two rods 341 which are connected to the second blade 32 and spaced apart. In this embodiment, the driven portion 34 is formed in an U shape with two top ends connected to the second blade 32. Or in another embodiment, the driven portion 34 is formed as two separate rods, one end of each rod is connected to the second blade 32. A gap 342 is formed between two rods 341. The moving member 24 stretches into the gap 342 right after both the shearing module 3 and the driving module 2 are assembled to the first shell 11. Referring to FIGS. 5 and 6, during the motor 21 driving the moving member 24 to move, the moving member 24 repeatedly pushes the two rods one after another so that the second blade 32 swings back and forth around the pivot module 5.

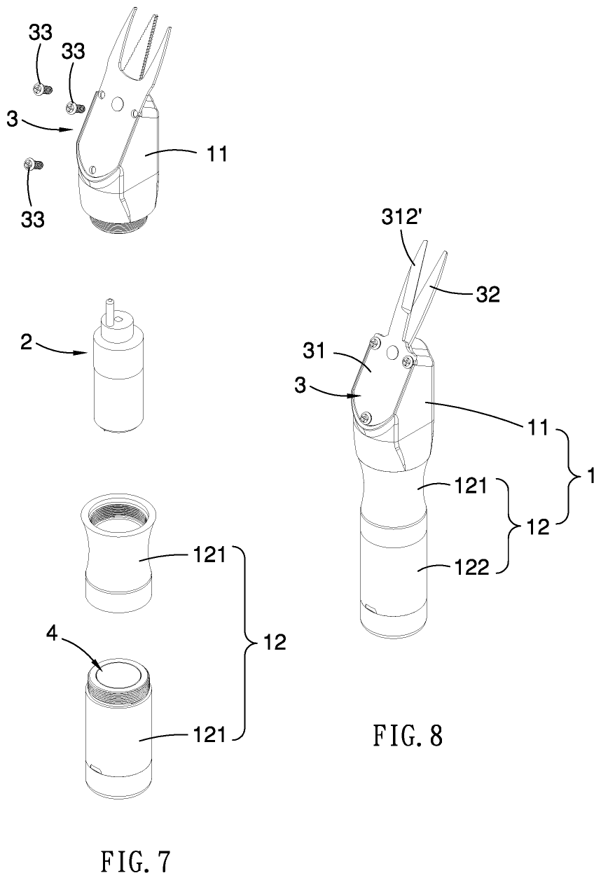

In this embodiment, the first blade 31 has two blade portions 312 spaced apart. The second blade 32 swings between the two blade portions 312, thereby forming two cutting openings for cutting. Or in another embodiment as shown in FIG. 8, the first blade 31 has single blade portion 312′, thereby forming only one cutting opening.

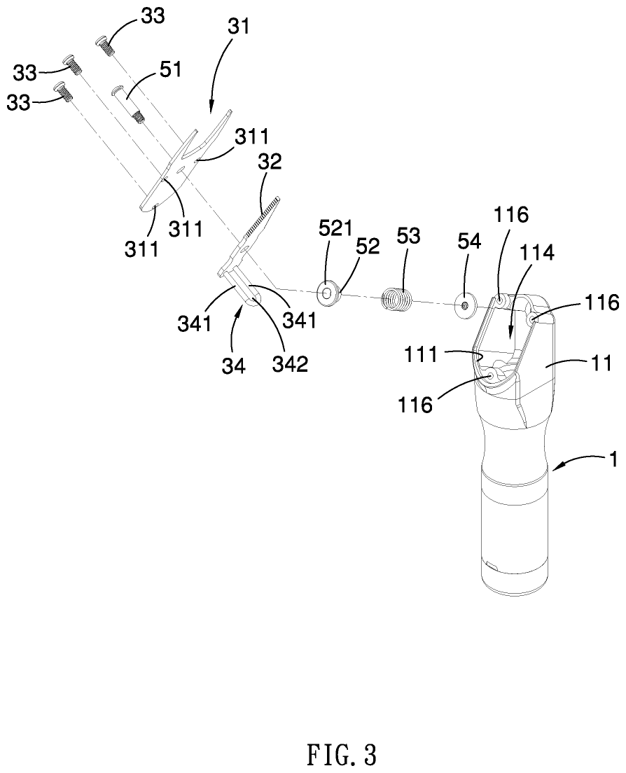

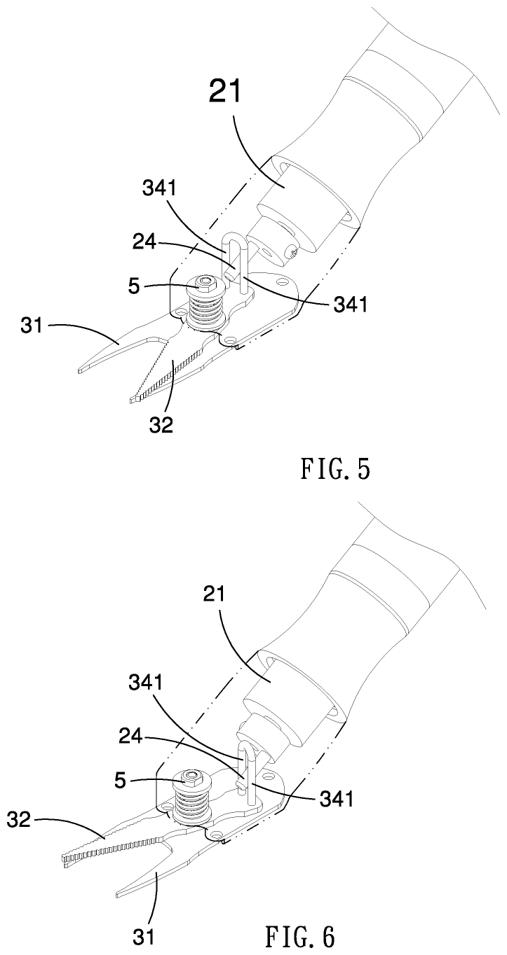

Referring to FIG. 4, electric scissors of the present invention can be separated into the shearing module 3, the driving module 2 and the power supply module 4. In this configuration, the moving member 24 of the driving module 2 is connected with the driven portion 34 of the shearing module 3 right after both the shearing module 3 and the driving module 2 are assembled to the first shell 11, no other action required. On the other hand, the power supply module 4 is received in the second shell 12, and the conductive board 411 of the power supply module 4 is connected with the conductive contact 27 of the driving module 2 right after the second shell 12 is assembled to the first shell 11, no other action required. Thus, referring to FIG. 7, user can easily assemble or disassemble the driving module 2 and the power supply module 4 by simply assembling or separating the first shell 11 and the second shell 12.

Moreover, since the shearing module 3 is simply fixed on the first shell 11 via three screws 33, user can easily assemble or disassemble the shearing module 3 by twisting the screws 33 for replacing blunt blades. It is even possible to change the shearing modules of different structures, such as the type of two cutting openings and the type of one cutting opening.

What is claimed is:

1. A pair of electric scissors comprising:
a housing including a first shell and a second shell detachably connected together;
a driving module detachably connected within the first shell including a driving member and a moving member driven by the driving member, the moving member extending into the first shell;
a shearing module detachably connected with the first shell including a driven portion that is connected with the moving member right after both the driving module and the shearing module are connected with the first shell; and
a power supply module detachably connected with the second shell, the power supply module being connected with the driving member right after the second shell is connected with the first shell.

2. The electric scissors according to claim 1, wherein the first shell and the second shell are arranged in a straight axis.

3. The electric scissors according to claim 2, wherein a bottom end of the first shell is screwed to a top end of the second shell.

4. The electric scissors according to claim 2, wherein the driving module and the power supply module are arranged in the straight axis.

5. The electric scissors according to claim 4, wherein the shearing module is arranged at an angle relative to the straight axis.

6. The electric scissors according to claim 1, wherein an upper space and a lower space are provided in an interior of the first shell, wherein the driving member is fitted with the first shell in the lower space while the moving member extends into the upper space.

7. The electric scissors according to claim 6, wherein a step portion is disposed in the first shell to divide the interior into the upper space and the lower space, the driving member being positioned with engaging with the step portion, wherein a washer is provided between the driving member and the step portion.

8. The electric scissors according to claim 1, wherein the driving member includes a motor and a circuit board disposed under the motor, a conductive contact being provided on a surface of the circuit board facing the power supply module.

9. The electric scissors according to claim 8, wherein the power supply module includes a battery and a switch, a conductive board coupled to the conductive contact being disposed on a side of the battery facing the circuit board, the switch being disposed on another side of the battery opposite to the side of the battery facing the circuit board.

10. The electric scissors according to claim 9, wherein a charging connector is disposed on a radial side of the battery.

11. The electric scissors according to claim 9, wherein a bottom end of the second shell is connected with a bottom cover with a button linked to the switch.

12. The electric scissors according to claim 1, wherein the driving member includes a motor with an output shaft, the output shaft being connected with a rotating base, the moving member being disposed on the rotating base in a position different from that of the output shaft so that the moving member moves along with a rotation of the rotating base.

13. The electric scissors according to claim 1, wherein the shearing module includes a first blade and a second blade, the first blade being fixed with the first shell, the second blade being pivotally connected to the first blade with a pivot module, the driven portion being disposed on the second blade.

14. The electric scissors according to claim 13, wherein at least one screw hole is provided on the first shell while the first blade is fixed by at least one screw locked in corresponding screw hole.

15. The electric scissors according to claim 13, wherein the driven portion includes two rods spaced apart, the moving member extending between the two rods and repeatedly pushing the two rods one after another so that the second blade swings back and forth.

16. The electric scissors according to claim 13, wherein the pivot module includes a pivot rod, a sleeve with a bottom plate, a spring and a supporting block, the pivot rod penetrating the first blade and the second blade and then is fixed with the supporting block, the sleeve being disposed around the pivot rod while the bottom plate engages with the second blade, the spring being disposed around the pivot rod and supported by the supporting block and the bottom plate.

17. The electric scissors according to claim 13, wherein the first blade includes two blade portions spaced apart, the second blade swinging between the two blade portions.

18. The electric scissors according to claim 1, wherein a part of the driving member sticks out from the first shell; wherein the second shell includes an upper portion detachably connected with the first shell and a lower portion detachably connected with the upper portion, the part of the driving member sticking out from the first shell being received within the upper portion, the power supply module being received within the lower portion.
